(19) United States
(12) Patent Application Publication
(10) Pub. No.: US 2026/0243225 A1
(43) Pub. Date: Aug. 20, 2026

(54) Automatic Level Adjusting Generator

(71) Applicant: Said S. Moobark, Vero Beach, FL (US)

(72) Inventor: Said S. Moobark, Vero Beach, FL (US)

(21) Appl. No.: 19/058,223

(22) Filed: Feb. 20, 2025

(51) Int. Cl. F03B 15/00; F03B 13/00; F03B 17/06; H02K 7/18

(52) U.S. Cl. CPC F03B 15/00; F03B 13/00; F03B 17/06; H02K 7/1823; F05B 2220/706; H02K 2213/09

(57) ABSTRACT

An adjustable river water generator may be automatically adjusted to the height of a river by a water level sensor electrically connected to hydraulic jacks. The electric generators and main shaft of the device are set on hydraulic lifts. The height of the generators is regulated by a water level sensor that raises or lowers the entire mechanism. Venturi tubes are located near the submerged paddles to increase the flow of the current onto the paddles so that the force of the current is amplified.

### BACKGOUND OF THE INVENTION

In order to generate electric current from natural sources, wind and water generators have been developed to transform the energy from wind or water to electricity. These generators are placed in a current and turn generators which in turn produce electricity. These water and wind current genertors are well known in the art of electric generation from water or wind.

One such electric generator utilizing water current is found in the US Patent #1,368,454 issued to J.J. Rebman. The Rebman device, issued in 1921, is now expired but provided a water generator from river current. The Rebman device was functional but lacked any mechanisms for detecting the river water level and adjusting the level of the main shaft to the ambient water level. Rebman also did not disclose the use of venturi tubes to increase the current of the water.

It is an object of this invention to disclose a river water generator for electricity whereby the device is raised or lowered according to the height of the river level.

It is still another object of this device to raise or lower the mechanism automatically using a water level sensor.

It is a still further object of this invention to utilize venturi tubes such that the venturi tubes increase the speed, and hence mechanical force, of the ambient water current.

Other and further objects of this invention will become obvious after reading the below described description of the device.

### BRIEF DESCRIPTION OF THE INVENTION

This device relates to the production of electricity by flowing water current, such as a river. The electric generators and main shaft of the device are hydraulic. The height of the device is regulated by a water level sensor that raises or lowers the entire mechanism. Venturi tubes are located near the submerged paddles to increase the flow of the current onto the paddles so that force of the current is amplified.

### DESCRIPTION OF THE DRAWING FIGURES

FIG. 1 is a schematic representation of the preferred embodiment of the mechanism in a river, showing the hydraulic lifts, the water level sensor and the paddles and main shaft.

FIG. 2 is another embodiment of the hydraulic device where the device is not affixed to the river bed,

FIG. 3 is another embodiment ofthe mechanism having a fixed position showing the venturi tubes but with no water level sensor and no raising or lowering of the device.

### DETAILED DESCRIPTION OF THE DEVICE

The river generator device provides rotors10 and electric generators 7 and 7’ attached to a main shaft 4 to generate electricity utilizing river, creek or other water current.

The device is used in a river 1 having a flowing current. The river has a floor 2 and sides 3 and 3’. A main shaft 4 is placed horizontally across the river as shown in the Drawing Figures. The main shaft 4 includes a plurality of man shaft bearings 5 so that the shaft turns freely. The main shaft 4 is connected to the shaft of an electrical generator by a mechanical coupling 6 as shown.

The device utilizes electrical generators on both the left 3 and right sides 3’ of the river. A left generator 7 and a right generator 7’ are connected to the main shaft 4 as shown in the Drawing Figures.

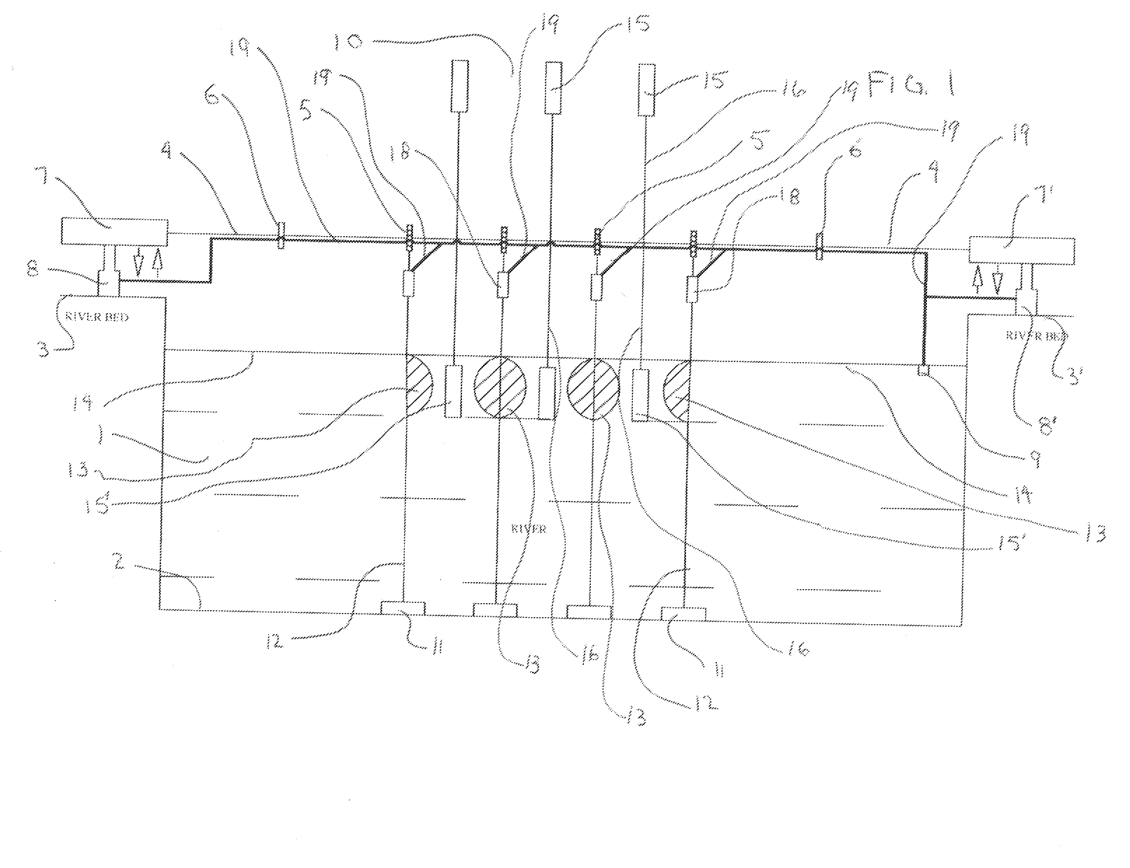

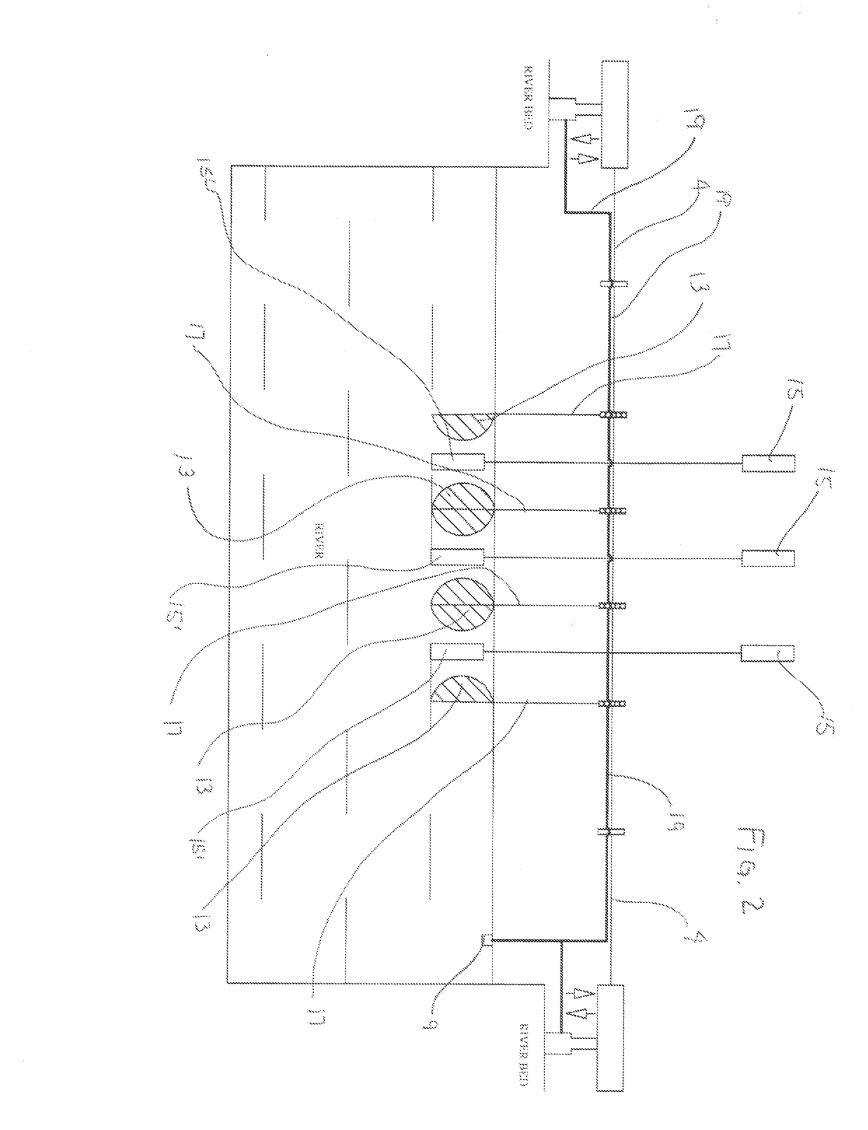

The left 7 and right 7’ generators are mounted on left 8 and right 8’ hydraulic mountings. The hydraulic mountings 8 and 8’ allow the main shaft 4 and paddles 10 to go up or down depending on the water level of the river or other flowing water system. The hydraulic mountings are controlled by a river water level sensor 9, shown on FIG. 1 and 2.

The electrical connections between the water sensor 9 and the hydraulic mountings 8 and 8’ are shown as a heavy line 19 on Drawing FIGS. 1 and 2.

This sensor 9 is well known in the art. Such sensors are capable of being electrically connected to a computer or other device that sends an electrical signal to the hydraulic mountings 8 and 8’ as the water level 14 of the river rises or falls. The electrical signal may be transmitted through wires as shown in the drawing figures or they may be sent ss a Wi-Fi signal. The means of transmitting the signal between the sensor and the hydraulic lifts shown as wires is meant as an illustration only and not as a limitation on the mechanism. One example of such a water level sensor is the WL705 ultrasonic water level sensor manufactured by The YSI Xylem Company. The sensor 9 ensures that the main shaft 4 of the device remains at a set level with respect to the water leve14 of the river.

Attached to the main shaft 4 are a plurality of rotors shown generally as 10. The number of rotors is determined by the width of river 1 and may range from at least two to a dozen or more.

Each rotor 10 comprises at least two paddles, a free paddle 15 and a submerged paddle 15’. It is to be appreciated that the location of the free and submerged paddles changes as the rotor 10 turns.

The rotor paddles 15 and 15’ are attached to a paddle at the end of the paddle shaft 16. Paddle shaft 16 is also attached to the main shaft 4 at a main shaft rotor paddle shaft end. The rotor paddles 15 and 15’ and rotor paddle shafts 16 are ultimately attached to the main shaft 4 as shown in the drawing figures. It has been found by experiment that the optimal configuration for the paddles 15 and 15’ is to have free paddles 15 and submerged paddles 15’ connected to the paddle shafts 16. When water is energizing the submerged paddle 15’, the free paddles 15 are out of the water and easily turn. As water moves in the river 1, the river current rotates paddles 15 and 15’ which turns the main shaft 4.

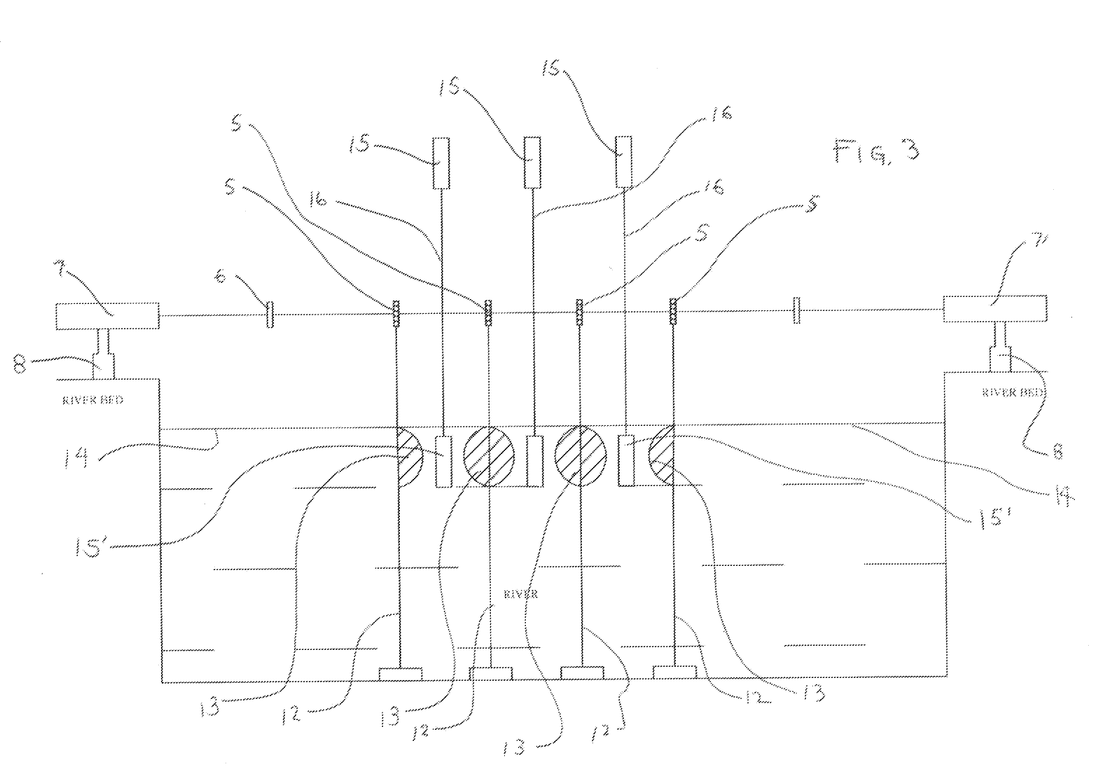

An important feature of this device are the venturi tubes 13 located near the submerged paddles 15’. Each paddle 10 has a These venturi tubes 13 restrict the river current as the river current pushes the submerged paddle. The venturi tubes make the river current go faster, thus increasing the force and speed at which each submerged paddle is energized. The venturi tubes 17 may be affixed to the fixing rods 12 as shown in FIG. 1 and FIG. 3.

One embodiment of the device is shown in FIG. 1 where the device is attached to the river bed at fixing rod bases 11 by fixing rods 12 as shown.

This first and preferred embodiment is shown in FIG. 1. In this embodiment, the main shaft 4 is raised or lowered according to the water level of the river by sensor 9. In this embodiment, the fixing rods 12 are mechanically connected to fixing rod hydraulic mechanisms 18. The hydraulic mechanisms 18 are electrically connected to the water level sensor 9. As the river water level 14 rises or falls, the water level sensor 9 electrically sends a signal to the hydraulic mechanisms 8 and 8’ and fixing rod hydraulic mechanisms 18 to raise or lower the main shaft 4 and rotors 10, simultaneously raising or lowering the electrical generators 7 and 7’. The sensor 9 is electrically connected between the water level sensor 9, and the hydraulic mechanisms 18 and 18’, and 8 and 8’. However, the electrical signal could also be sent wirelessly.

A plurality of venturi tubes 13 are located near the submerged paddle 15’ as shown in Drawing FIGS. 1, 2 and 3. The venturi tubes increase the velocity, and hence the force, of the current near the submerged paddles 15’. As shown in Figures these venturi tubes 13 are affixed in place to the fixing rods 12 as shown in FIGS. 1 and 3.

In a second, fixed, embodiment shown in FIG. 3, the main shaft 4 is permanently affixed to the river bed at a fixed position. This embodiment has no water level sensor or hydraulic mechanisms.

If the river is too deep, or for other design reasons, the device main shaft 4 may be connected to the rotors as shown in FIG. 2. In this deep embodiment, the venturi tubes 13 are connected by rods 17 to main shaft bearing housings and are permanently in place.

In operation, a river current or stream current (or other flowing water or wind source) is restricted by a plurality of venturi tubes 13 to increase the speed of the current. The faster current is directed to the surface of a submerged paddle 15’. Each submerged paddle15’ turn a shaft 16 which is mechanically connected to a main shaft 4. The main shaft 4 turns the electric generators 7 and 7’. The device may be raised or lowered by a water level sensor 9 in the preferred embodiment.

As an important feature of the device, a water level sensor 9 determines the height of the river and hydraulic jacks 8 and 8’ and 18 raise or lower the main shaft 4 according to the water level of the river.

Another important feature of this device are the venturi tubes 13 located bear the submerged paddles 15’ that accelerate the speed of the current.

I claim:

1. claim 1: In a device that generates electricity from a current or river water, a mechanism that comprises:
(a) a main shaft running horizontally across a current, such as the banks of a river, attached to hydraulic generator mounts located on left and right banks of said river;
(b) a plurality of paddles mechanically connected to said main shaft by paddle shafts;
(c) fixing rods mechanically connected to the river bed and the main shaft, wherein said fixing rods each have an hydraulic mechanism that raises or lowers the main shaft upon receiving signals from a water level sensor;
(d) a water level sensor electrically connected to the hydraulic connections of said generator mounts and said fixing rod hydraulic mechanisms;
whereby the level of said device may be raised or lowered according to the level of said river by electrical signals from the water level sensor.

2. claim 2: In a device that generates electricity from river water, the improvement further comprising venturi tubes located near submerged paddles to accelerate the speed of the current.
